(19) United States
(12) Patent Application Publication
(10) Pub. No.: US 2022/0230102 A1
(43) Pub. Date: Jul. 21, 2022

(54) TECHNIQUES FOR INCREASING COMPUTING SPEED OF OPTIMIZED MATCHES BETWEEN GROUPS WITH MUTUAL RANKED PREFERENCES

(71) Applicant: University of Washington, Seattle, WA (US)

(72) Inventors: Aaron Y. Lee, Seattle, WA (US); Russell N. Van Gelder, Seattle, WA (US); Yue Wu, Seattle, WA (US)

(73) Assignee: University of Washington, Seattle, WA (US)

(21) Appl. No.: 17/578,849

(22) Filed: Jan. 19, 2022

Related U.S. Application Data
(60) Provisional application No. 63/140,164, filed on Jan. 21, 2021.

(51) Int. Cl. G06Q 10/04; G06Q 10/06

(52) U.S. Cl. CPC G06Q 10/04; G06Q 10/063118

(57) ABSTRACT

In some embodiments, a computer-implemented method of matching parties in a set of parties with counter-parties in a set of counter-parties is provided. A computing system receives counter-party preferences from each party in the set of parties. The computing system receives party preferences and indications of available positions from each counter-party in the set of counter-parties. The computing system computes a globally optimal pairing of parties of the set of parties with counter-parties of the set of counter-parties. The computing system stores the globally optimal pairing.

### CROSS-REFERENCE TO RELATED APPLICATION

This application claims the benefit of Provisional Application No. 63/140164, filed Jan. 21, 2021, the entire disclosure of which is hereby incorporated by reference herein for all purposes.

### BACKGROUND

One common problem faced is the matching of parties with counter-parties wherein both sides of the match have preferences regarding the other side, sometimes referred to as the stable matching problem. One non-limiting example of this problem is the problem of matching parties such as medical residents to counter-parties such as residency placements at programs, wherein the medical residents have preferences regarding which programs they wish to be assigned to, and wherein the programs have preferences regarding which medical residences they wish to accept. Techniques exist for solving this problem, but the techniques suffer from large amounts of technical inefficiency and produce sub-optimal matches.

The resident matching algorithm currently used by SF Match and the National Residency Match Program (NRMP)—Gale-Shapley—has been in use for over 50 years without fundamental alteration. A stable marriage algorithm was introduced by Mullin and Stalnaker in 1952 as a method of matching medical students into residency programs. Since its deployment, only minor modifications have been made despite a large shift in the supply and demand for residency positions. The stable marriage algorithm, proven by Gale and Shapley in 1962, matches parties and counter-parties into stable pairs (each party is matched to a counter-party and vice versa), given that there are an equal number of participants in both groups and that each participant ranks every potential partner. The matches are stable when there is no applicant matched to a program while preferring a different program, and that program also prefers this applicant to one of its matches.

Changing trends in the residency matching process over the years, however, render some of the idealized results of stable marriage algorithms irrelevant. For example, the number of medical residents and residency positions offered by programs are not comparable, but instead are highly imbalanced, especially in specialties such as ophthalmology. This has strained the match process over time such that medical residents apply to many more programs and programs likewise interview more applicants, increasing costs for all. More importantly, while medical residents outnumber residency positions at the moment, not all positions are filled because the parties do not submit full rank lists of all counter-parties, and vice versa. These unfilled positions mush then be filled using other techniques, such as the “Scramble.”

In addition, stable marriage algorithms identify a “proposal side” in order for their techniques to work effectively. In these techniques, one group “proposes” (i.e., signals their ranked choices) to the other side, which then responds with its rankings. The proposal side is then intrinsically favored by the stable marriage algorithm. Accordingly, the choice of the proposal side has been controversial historically. The last update of the NRMP algorithm in 1997 switched the proposal side from programs to medical residents, while SF Match has favored medical residents since its inception in 1977.

Finally, stable marriage algorithms require strict ordinal rank lists, which do not allow ties. In addition, they cannot capture relative preferences. For example, a medical resident may much more prefer their top choice to their second choice program. It has been shown that ordinal ranks differ substantially from medical residents' marginal preferences.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some embodiments, a computer-implemented method of matching parties in a set of parties with counter-parties in a set of counter-parties is provided. A computing system receives counter-party preferences from each party in the set of parties. The computing system receives party preferences and indications of available positions from each counter-party in the set of counter-parties. The computing system computes a globally optimal pairing of parties of the set of parties with counter-parties of the set of counter-parties. The computing system stores the globally optimal pairing.

In some embodiments, a computing system is provided that includes at least one processor and a computer-readable medium. The computer-readable medium has computer-executable instructions stored thereon that, in response to execution by the at least one processor, cause the computing system to perform actions for matching parties in a set of parties with counter-parties in a set of counter-parties. The actions include receiving, by the computing system, counter-party preferences from each party in the set of parties; receiving, by the computing system, party preferences and indications of available positions from each counter-party in the set of counter-parties; computing, by the computing system, a globally optimal pairing of parties of the set of parties with counter-parties of the set of counter-parties; and storing, by the computing system, the globally optimal pairing.

In some embodiments, a non-transitory computer-readable medium is provided. The computer-readable medium has computer-executable instructions stored thereon that, in response to execution by the at least one processor, cause the computing system to perform actions for matching parties in a set of parties with counter-parties in a set of counter-parties.

The actions include receiving, by the computing system, counter-party preferences from each party in the set of parties; receiving, by the computing system, party preferences and indications of available positions from each counter-party in the set of counter-parties; computing, by the computing system, a globally optimal pairing of parties of the set of parties with counter-parties of the set of counter-parties; and storing, by the computing system, the globally optimal pairing.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram that illustrates aspects of a non-limiting example embodiment of a match management computing system according to various aspects of the present disclosure.

FIG. 2 is a flowchart illustrating a non-limiting example embodiment of a method of matching parties in a set of parties with counter-parties in a set of counter-parties according to various aspects of the present disclosure.

FIG. 3A is a chart that illustrates a comparison of the matched ranks generated by the embodiment of the present disclosure to the matched ranks generated by the Gale-Shapley technique.

FIG. 3B is a chart that illustrates another comparison of the ranks of matches determined by Gale-Shapley versus the matches determined by the embodiment of the present disclosure.

FIG. 4 is a stacked bar chart that illustrates changes in applicant status between the Gale-Shapley technique and the embodiment of the present disclosure.

FIG. 5 is an alluvial plot that visualizes the swaps that occurred when comparing the results from the embodiment of the present disclosure to the results from Gayle-Shapley.

FIG. 6 is a chart that illustrates execution times with error bars for a non-limiting example embodiment of the present disclosure and an example implementation of the Gale-Shapley technique.

### DETAILED DESCRIPTION

In the present disclosure, novel techniques are provided for matching parties with counter-parties that maximize the global welfare of all entities without favoring either side. These novel techniques both increase the speed of computing matches and improve the quality of the matches that are computed. The improved quality and improved speed are shown using actual test results for retrospective rank-list data.

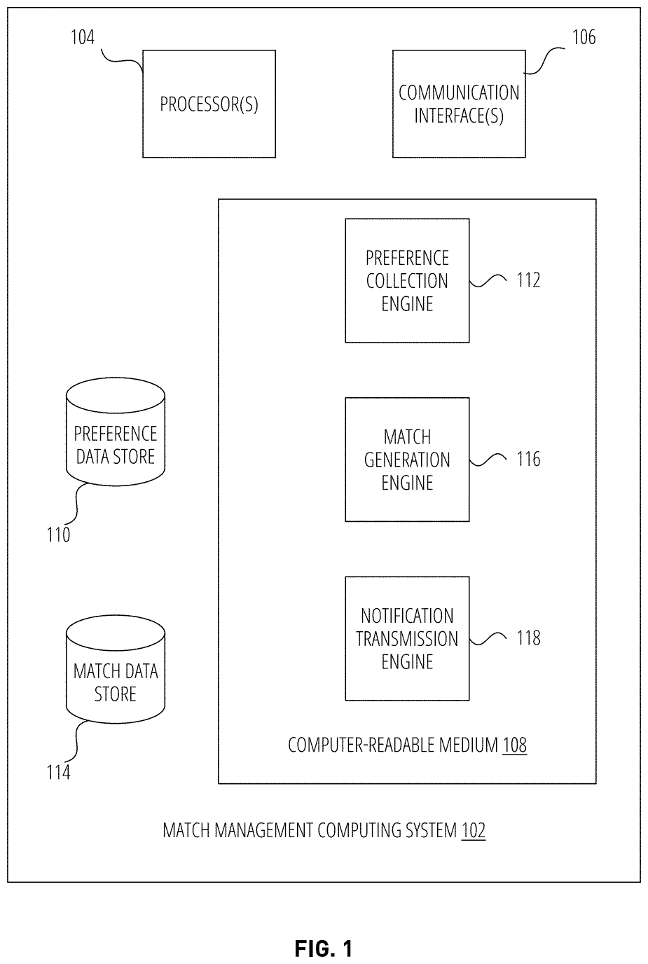

FIG. 1 is a block diagram that illustrates aspects of a non-limiting example embodiment of a match management computing system according to various aspects of the present disclosure. The illustrated match management computing system 102 may be implemented by any computing device or collection of computing devices, including but not limited to a desktop computing device, a laptop computing device, a mobile computing device, a server computing device, a computing device of a cloud computing system, and/or combinations thereof. The match management computing system 102 is configured to receive preferences from a set of parties and a set of counter-parties, and to determine an optimal match for the parties and counter-parties using techniques that provide improved computational efficiency.

As shown, the match management computing system 102 includes one or more processors 104, one or more communication interfaces 106, a preference data store 110, a match data store 114, and a computer-readable medium 108.

In some embodiments, the processors 104 may include any suitable type of general-purpose computer processor. In some embodiments, the processors 104 may include one or more special-purpose computer processors or AI accelerators optimized for specific computing tasks, including but not limited to graphical processing units (GPUs), vision processing units (VPTs), and tensor processing units (TPUs).

In some embodiments, the communication interfaces 106 include one or more hardware and or software interfaces suitable for providing communication links between components. The communication interfaces 106 may support one or more wired communication technologies (including but not limited to Ethernet, FireWire, and USB), one or more wireless communication technologies (including but not limited to Wi-Fi, WiMAX, Bluetooth, 2G, 3G, 4G, 5G, and LTE), and/or combinations thereof.

As shown, the computer-readable medium 108 has stored thereon logic that, in response to execution by the one or more processors 104, cause the match management computing system 102 to provide a preference collection engine 112, a match generation engine 116, and a notification transmission engine 118.

In some embodiments, the preference collection engine 112 is configured to receive preferences from the set of parties and the set of counter-parties, and to store the preferences in the preference data store 110. In some embodiments, the match generation engine 116 is configured to determine an optimal set of matches based on the preferences stored in the preference data store 110, and to store the set of matches in the match data store 114. In some embodiments, the notification transmission engine 118 is configured to transmit notifications of matches stored in the match data store 114 to the set of parties and the set of counter-parties.

Further description of the configuration of each of these components is provided below.

As used herein, “computer-readable medium” refers to a removable or nonremovable device that implements any technology capable of storing information in a volatile or non-volatile manner to be read by a processor of a computing device, including but not limited to: a hard drive; a flash memory; a solid state drive; random-access memory (RAM); read-only memory (ROM); a CD-ROM, a DVD, or other disk storage; a magnetic cassette; a magnetic tape; and a magnetic disk storage.

As used herein, “engine” refers to logic embodied in hardware or software instructions, which can be written in one or more programming languages, including but not limited to C, C++, C#, COBOL, JAVA™, PHP, Perl, HTML, CSS, JavaScript, VBScript, ASPX, Go, and Python. An engine may be compiled into executable programs or written in interpreted programming languages. Software engines may be callable from other engines or from themselves. Generally, the engines described herein refer to logical modules that can be merged with other engines, or can be divided into sub-engines. The engines can be implemented by logic stored in any type of computer-readable medium or computer storage device and be stored on and executed by one or more general purpose computers, thus creating a special purpose computer configured to provide the engine or the functionality thereof. The engines can be implemented by logic programmed into an application-specific integrated circuit (ASIC), a field-programmable gate array (FPGA), or another hardware device.

As used herein, “data store” refers to any suitable device configured to store data for access by a computing device. One example of a data store is a highly reliable, high-speed relational database management system (DBMS) executing on one or more computing devices and accessible over a high-speed network. Another example of a data store is a key-value store. However, any other suitable storage technique and/or device capable of quickly and reliably providing the stored data in response to queries may be used, and the computing device may be accessible locally instead of over a network, or may be provided as a cloud-based service. A data store may also include data stored in an organized manner on a computer-readable storage medium, such as a hard disk drive, a flash memory, RAM, ROM, or any other type of computer-readable storage medium. One of ordinary skill in the art will recognize that separate data stores described herein may be combined into a single data store, and/or a single data store described herein may be separated into multiple data stores, without departing from the scope of the present disclosure.

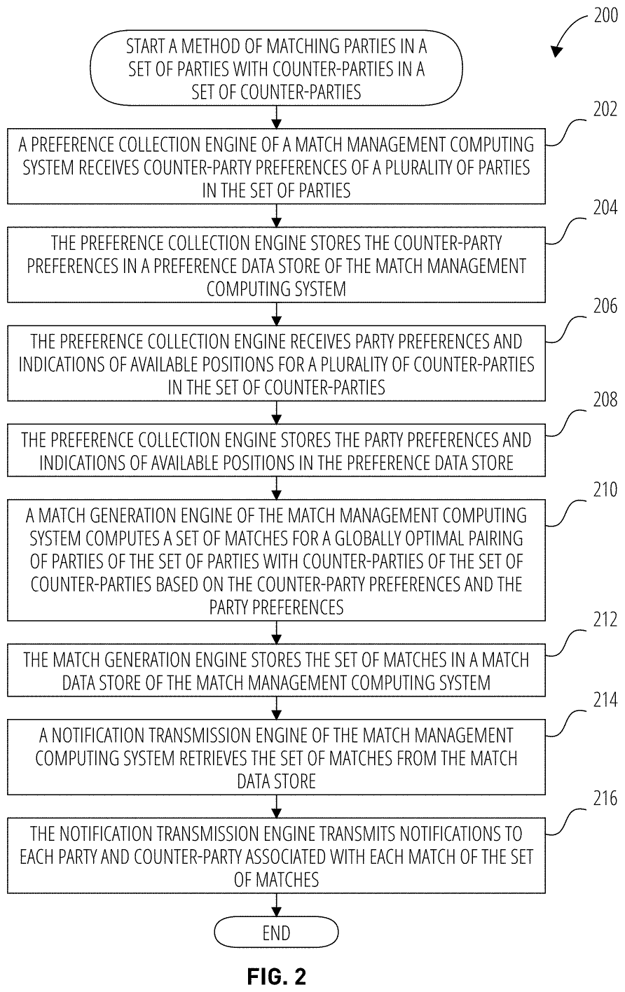

FIG. 2 is a flowchart illustrating a non-limiting example embodiment of a method of matching parties in a set of parties with counter-parties in a set of counter-parties according to various aspects of the present disclosure. In some embodiments, the parties may be medical residents and the counter-parties may be programs with residency positions to be matched. In other embodiments, the parties and/or counter-parties may be other types of people or entities with mutual preferences, including but not limited to school applicants and schools; job applicants and employers; potential dating partners; or any other types of potential partners with mutual preferences.

One will note that since there is no “proposal side” identified in the method 200, the identity of which side is assigned as the “party” and which side is assigned as the “counter-party” is immaterial, and the sides may be switched without affecting the efficacy of the method 200. For example, the medical residents may be the parties while the programs may be the counter-parties, or the programs may be the parties while the medical residents may be the counter-parties, without any change in the outcome of the method 200. That said, in some embodiments, a single counter-party may have multiple positions to be matched (such as a given program having room for more than one medical resident), while each party is a single entity (such as a given medical resident), so multiple parties may be matched to a single counter-party but not vice-versa. In other embodiments, multiple positions for a given program may be processed as separate counter-parties, with party preferences assigned appropriately to each position.

From a start block, the method 200 proceeds to block 202, where a preference collection engine 112 of a match management computing system 102 receives counter-party preferences of a plurality of parties in the set of parties. In some embodiments, the preference collection engine 112 may generate a user interface (e.g., a web interface) that allows each party to input their counter-party preferences. In some embodiments, the preference collection engine 112 may provide an application programming interface (API) that allows a software program to submit counter-party preferences for parties.

In some embodiments, the counter-party preferences for a party indicate preferences that the party has for one or more of the counter-parties. In some embodiments, the counter-party preferences for a party may indicate preferences for all of the counter-parties. In some embodiments, the counter-party preferences for a party may indicate preferences for less than all of the counter-parties.

The counter-party preferences may be indicated in any suitable format. In some embodiments, the counter-party preferences may be provided as a stack rank of the counter-parties (e.g., counter-party X is assigned Rank 1, counter-party Y is assigned Rank 2, counter-party Z is assigned Rank 3, etc.). In some embodiments, the counter-party preferences may be provided as a rating of the counter-parties on any suitable scale (e.g., counter-party X is assigned a five-star rating, counter-party Y is assigned a four-star rating, counter-party Z is assigned a two-star rating, etc.). In some embodiments, some counter-parties may be assigned matching counter-party preferences (e.g., counter-party X is assigned a five-star rating, and counter-party Y is also assigned a five-star rating; counter-party X and counter-party Y are both assigned Rank 1, etc.). In some embodiments, the counter-party preferences for all of the parties are submitted in matching formats. In some embodiments, the counter-party preferences for some parties may be presented in a first format, while counter-party preferences for other parties may be presented in another format or formats.

At block 204, the preference collection engine 112 stores the counter-party preferences in a preference data store 110 of the match management computing system 102. In some embodiments, the preference collection engine 112 creates a record in the preference data store 110 that includes all of the counter-party preferences and identifies the party for whom the counter-party preferences are applicable. In some embodiments, the record may also be associated with a record for the party that includes information about the party including but not limited to contact information (e.g., email address, phone number, etc.).

At block 206, the preference collection engine 112 receives party preferences and indications of available positions of a plurality of counter-parties in the set of counter-parties. As with the collection of the counter-party preferences, the preference collection engine 112 may collect the party preferences and indications of available positions using any suitable technique (e.g., generating a user interface for entry of the party preferences, providing an API for submission of the party preferences, etc.), and the party preferences may be provided in any similar format or formats (e.g., stack rank, ratings, etc.). Likewise, each counter-party may provide party preferences for all of the parties or less than all of the parties.

At block 208, the preference collection engine 112 stores the party preferences and the indications of available positions in the preference data store 110. In some embodiments, the preference collection engine 112 creates a record in the preference data store 110 that includes all of the party preferences and identifies the counter-party for whom the counter-party preferences are applicable. In some embodiments, the record may also be associated with a record for the counter-party that includes information about the counter-party including but not limited to contact information (e.g., email address, phone number, etc.) and the indication of available positions.

At block 210, a match generation engine 116 of the match management computing system 102 computes a set of matches for a globally optimal pairing of parties of the set of parties with counter-parties of the set of counter-parties based on the counter-party preferences and the party preferences. While previously used techniques such as Gayle-Shapley required iterative processing of the preferences of the parties and the counter-parties, embodiments of the present disclosure determine the matches based on a global optimization of a utility function based on the preferences. By using a global optimization instead of an iterative technique, a faster result and a better match are both achieved.

Any suitable technique in which an optimization technique in which a global utility function derived from the party preferences and the counter-party preferences is maximized subject to constraints on a solution space may be used. Some non-limiting examples of suitable optimization techniques include a linear programming technique, a quadratic programming technique, a simplex technique, a Nelder-Mead technique, an interior point technique, an active-set technique, a Lagrangian technique, an augmented-Lagrangian technique, a gradient technique, a conjugate gradient technique, a nonlinear programming technique, an entropy maximization technique, or a convex optimization technique.

One additional non-limiting example of a suitable optimization technique is a mixed integer linear programming technique. For a mixed integer linear programming technique, the matching problem may be defined as minimizing a linear combination f^{T}ₓ subject to the following constraints:

$${min}_{x} {f}^{T} x subject to \{ \begin{matrix}x ( i n t c o n ) are integers \\ A \cdot x \leq b \\ Aeq \cdot x = beq \\ lb \leq x \leq ub\end{matrix}$$

In this equation, x is a matrix that corresponds to a p×n pairing matrix, where p is the number of parties and n is the number of counter-parties. Element xᵢⱼ is 1 if party j matched to counter-party i, and is 0 otherwise. The constraint b is a vector indicating available positions for each counter-party. Since each party will only match once, b may also include single positions for each party. Accordingly, b may be a vector of n*1 for the parties and p*positions for the counter-parties. The constraint beq is the number of available positions for all counter-parties. The constraints lb and ub are matrices of 0s and 1s, as a party either matches to a counter-party or does not. A is a linear inequality constraint matrix that represents the condition that the counter-parties match no more than their available positions as indicated by b. Similarly, Aeq is a linear equality constraint matrix that represents the condition that all positions (beq) are matched. If fewer than all positions may be matched, this condition may be relaxed. The term intcon is a vector of integer constraints, as it corresponds to the match matrix and all elements in the match matrix are either 0 or 1. Finally, f is a p×n coefficient matrix that corresponds to the combined party preferences and counter-party preferences.

By setting the constraint beq to the number of available positions for all counter-parties, the solver will attempt to match all of the available positions. This results in the method 200 being more robust and less liable to not fill all of the positions compared to previous techniques such as Gale-Shapley.

In some embodiments, at least one of the counter-party preferences and the party preferences are normalized before being combined in the matrix f. For counter-party preferences and party preferences that are provided as rankings, one non-limiting example embodiment of normalization of these values is to convert the party preferences to “tiers.” That is, if a counter-party has multiple available slots, then the party preferences for the counter-parties will be converted based on how many times all of the slots would have to be filled to reach the given party.

For example, if a counter-party has three slots available, then the first three parties in the counter-party's stack rank of party preferences are the first “tier” and have a normalized party preference of 1, the next three parties in the counter-party's stack rank of party preferences are the second “tier” and have a normalized party preference of 2, and so on. This allows ranked values in counter-party preferences (for which only a single spot is available) to be compared apples-to-apples with ranked values in party preferences (for which multiple spots may be available), and so a linear combination of the two values is effective. This normalization also a fair match to be conducted by the solver for counter-parties that have different numbers of open slots. A raw rank of #18 for a party by a counter-party with 6 open slots (effectively a third-tier preference) would look much worse to the optimizer than a raw rank of #9 for a party by a counter-party with 3 open slots (which is also effectively a third-tier preference)—the normalization described above would allow these two party preferences to be given the same weight by the optimizer.

In some embodiments in which counter-party preferences and/or party preferences are provided in different formats (e.g., an absolute scale such as a rating on a scale of 0-10, or 0 to 5 stars) instead of relative rankings, other types of normalization may be performed. In one non-limiting example, the absolute scale ratings may be converted to be on a scale from 0-1, and providing the ratings as real values to the optimizer. In another non-limiting example, the absolute scale ratings may be converted into stack rank rankings and processed as described above.

Once the match is described as a mixed integer linear programming problem, any suitable mixed integer linear programming solver may be used to determine the globally optimal pairing. In one non-limiting example embodiment, the INTLINPROG function of Matlab R2019b may be used. In other embodiments, other solvers, including but not limited to the GLOP solver provided by Google or the Pyomo solver by Hart, Watson, and Woodruff may be used. To further improve efficiency of the solver, sparse representations may be used for the constraints, thereby greatly reducing the amount of memory used.

At block 212, the match generation engine 116 stores the set of matches in a match data store 114 of the match management computing system 102. In some embodiments, the match generation engine 116 may store the pairing matrix x in the match data store 114. In some embodiments, the match generation engine 116 may create records for each match represented in the pairing matrix x in order to simplify further processing.

At block 214, a notification transmission engine 118 of the match management computing system 102 retrieves the set of matches from the match data store 114, and block 216, the notification transmission engine 118 transmits notifications to each party and counter-party associated with each match of the set of matches. The notification transmission engine 118 may load each match from the set of matches, determine contact information for the associated party and counter-party based on information stored in the preference data store 110, and transmit notifications to each party and counter-party using any suitable technique (including but not limited to email, SMS, telephone call, and app notifications). In some embodiments, the notification transmission engine 118 may generate a user interface that allows parties and counter-parties to view their associated matches from the set of matches store din the match data store 114.

The method 200 then proceeds to an end block and terminates.

Performance of an embodiment of the method 200 described above utilizing a mixed integer linear programming technique was analyzed and compared to historical performance of a Gale-Shapley matching technique over actual data for medical resident/program matches from a nine year period (2011-2019).On average, 628.6 applicants (parties) applied to 467.2 positions (available spots at counter-parties) and filled 99.4% of these positions. An average applicant ranked 8.9 programs, and an average program ranked 11.5 applicants per spot.

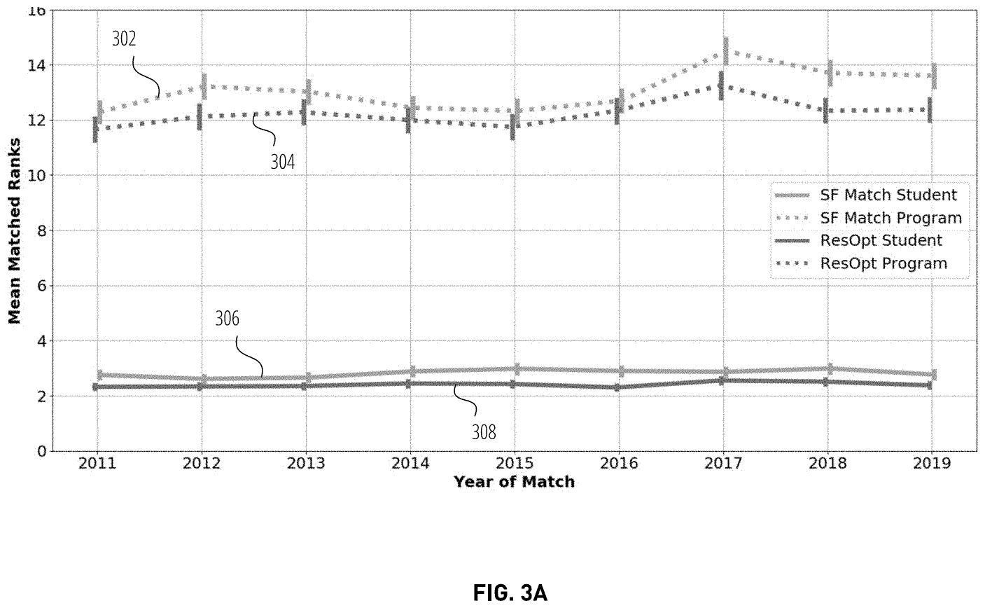

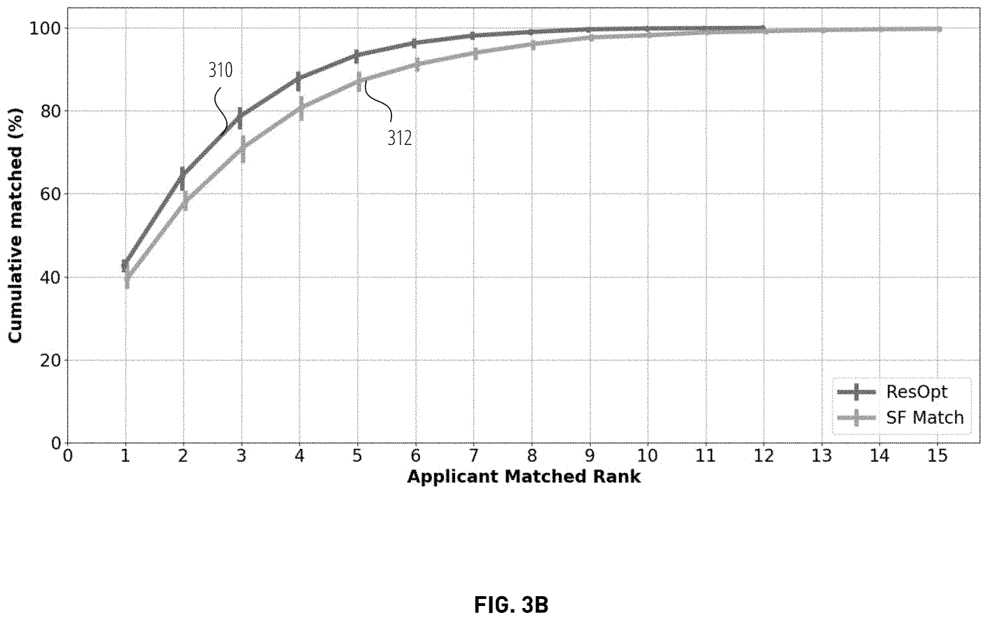

FIG. 3A is a chart that illustrates a comparison of the matched ranks generated by the embodiment of the present disclosure to the matched ranks generated by the Gale-Shapley technique. A first line 302 illustrates the mean rank of the matched applicants assigned by each program under Gale-Shapley, a second line 304 illustrates the mean rank of the matched applicants assigned by each program under the embodiment of the present disclosure, a third line 306 illustrates the mean rank of the matched programs assigned by each applicant under Gale-Shapley, and a fourth line 308 illustrates the mean rank of the matched programs assigned by each applicant under the embodiment of the present disclosure. For all rank values, lower is better (i.e., the match was for a party or counter-party that was assigned a higher place in the stack ranking).

Compared to the previous technique, the embodiment of the present disclosure provided average matched ranks that were statistically significantly lower (i.e., more desirable) for both the party and the counter-party across all years tested. Furthermore, the embodiment of the present disclosure lowered the average matched applicant ranks or improved the average matched candidate for programs across all years, and significantly so in four of the nine years. The embodiment of the present disclosure matched all 4205 available positions between 2011-2019, while the Gale-Shapley technique matched only 4181 (99.4%). In addition, the average applicant rank of matched programs was lowered or improved by 0.42 by the embodiment of the present disclosure (2.40=10102/4205) compared to Gale-Shapley (2.82=11803/4181). Similarly, on the program side, the average program rank of matched applicants was lowered by 0.86 by the embodiment of the present disclosure (12.23=51443/4205) compared to Gale-Shapley (13.09=54741/4181).

FIG. 3B is a chart that illustrates another comparison of the ranks of matches determined by Gale-Shapley versus the matches determined by the embodiment of the present disclosure. A fifth line 310 illustrates a cumulative match percentage for the embodiment of the present disclosure, and a sixth line 312 illustrates a cumulative match percentage for Gale-Shapley (higher is better). The improvement in the applicant matches for the present disclosure compared to Gale-Shapley was statistically significant when comparing the percentage of applicants matching to their top N ranked programs. For example, the embodiment of the present disclosure placed 78.7% (3308/4205) of matched applicants in one of their top three choices of programs, versus 71.5% (2291/4181) for Gale-Shapley.

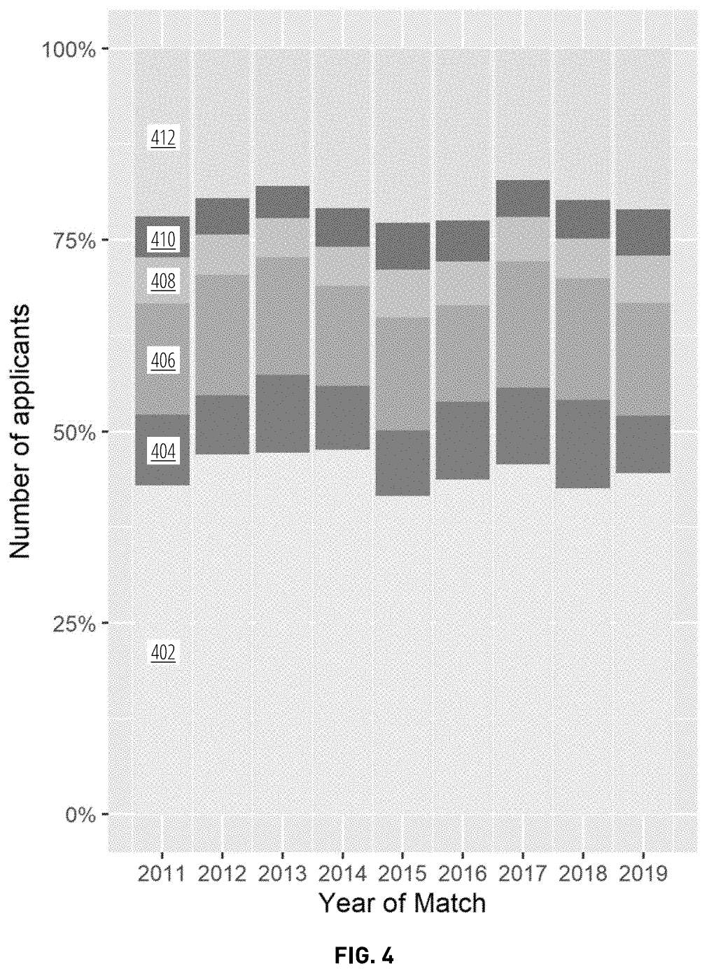

FIG. 4 is a stacked bar chart that illustrates changes in applicant status between the Gale-Shapley technique and the embodiment of the present disclosure. The data illustrates a total of 5657 applicants from 2011-2019. The data for 2011 is labeled with a first bar 402, a second bar 404, a third bar 406, a fourth bar 408, a fifth bar 410, and a sixth bar 412. The data for each other year includes bars stacked in the same order that represent matching data, but they have not been labeled for the sake of clarity. The first bar 402 represents applicants that matched to the same program with the embodiment of the present disclosure compared to Gale-Shapley, the second bar 404 represents applicants that matched to a more preferred program (a program of a higher rank), the third bar 406 represents applicants that matched to a less preferred program (a program of lower rank), the fourth bar 408 represents applicants that were unmatched by Gale-Shapley but are matched by the embodiment of the present disclosure, the fifth bar 410 represents applicants that were matched by Gale-Shapley but are unmatched by the embodiment of the present disclosure, and the sixth bar 412 represents applicants that were unmatched by both Gale-Shapley and the embodiment of the present disclosure.

On average, 44.7% (2528/5657) applicants match the same program (first bar 402). Another 9.2% (523/5657) match a more preferred program (second bar 404), while 14.8% (835/5657) match a less preferred program (third bar 406). 5.6% (319/5657) previously unmatched are matched (fourth bar 408), while 5.2% (295/5657) previously matched are unmatched.

Overall, the embodiment of the present disclosure matched 24 more positions than Gale-Shapley. Moreover, while 835 previously matched applicants match a less preferred program compared to 523 who improved their match, the total ranks lost by the 835 is 1822 and the total ranks gained by the 523 is 2121, for a net overall gain of 299 ranks, indicating a more optimal solution for the group as a whole. Finally, the 295 previously matched that are now unmatched had an average matched program rank of 6.40 (1889/295), while the 319 newly matched had an average matched program rank of 1.53 (487/319), for a net gain of 4.87 (6.40-1.53) per position. The embodiment of the present disclosure improved overall applicant welfare by swapping out applicants who previously matched less preferred programs for previously unmatched applicants that can match more preferred choices, as well as shuffling some previously matched applicants to lower overall matched ranks.

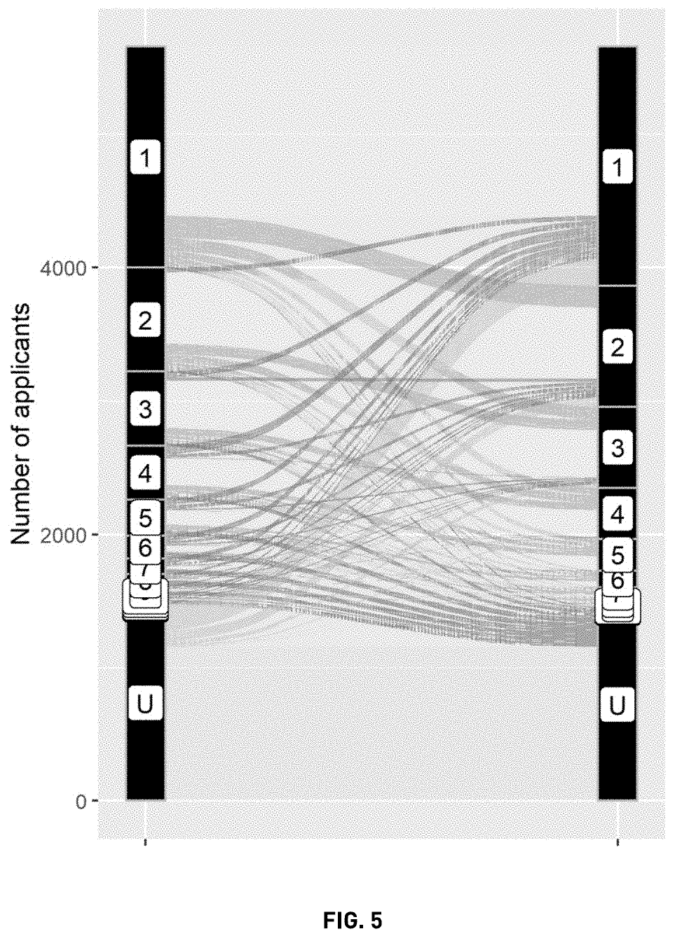

FIG. 5 is an alluvial plot that visualizes the swaps that occurred when comparing the results from the embodiment of the present disclosure to the results from Gayle-Shapley. The applicants' ranks for the programs they matched under Gale-Shapley are on the left side, and the applicants' ranks for the programs they matched under the embodiment of the present disclosure are on the right side. The left and right axes are scaled linearly according to the number of applicants, with 5657 total applicants and approximately 4200 matched from 2011-2019. Many of the outflows from the left to the right that change levels downward are to programs that are one rank lower, which allows for more outflows from the left to the right that are one or more ranks higher. Consequently, the height of the top three ranks is much taller on the right than on the left, meaning more applicants matched to one of their top three choices in the embodiment of the present disclosure versus Gale-Shapley.

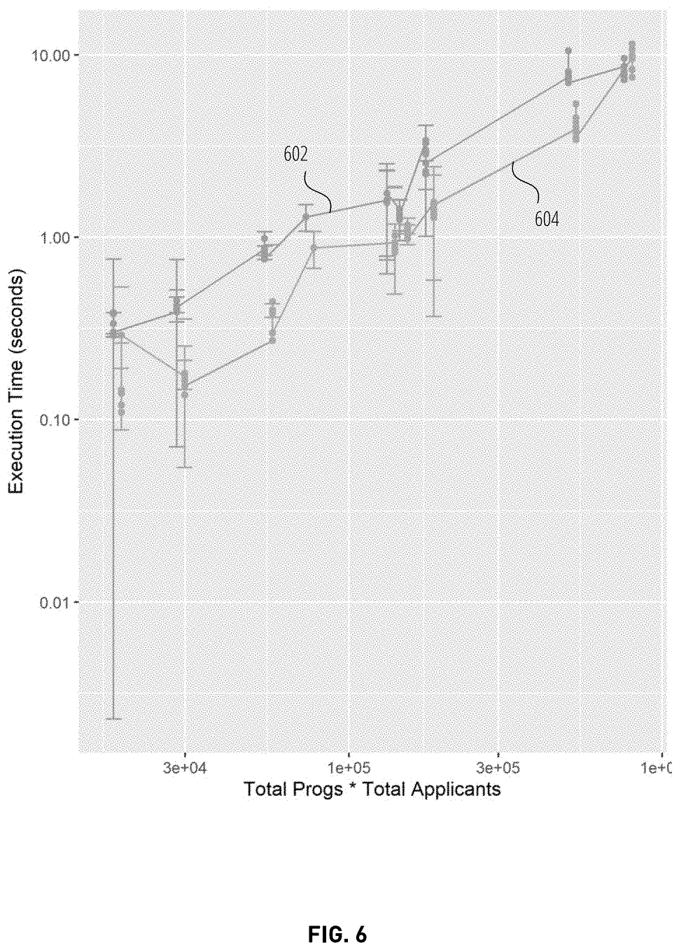

It is important to note that even with the qualitative improvements described above, the techniques disclosed herein also provide massive gains in computational efficiency compared to previously used techniques such as Gale-Shapley. FIG. 6 is a chart that illustrates execution times with error bars for a non-limiting example embodiment of the present disclosure and an example implementation of the Gale-Shapley technique. The illustrated chart shows 10 paired runs at a range of numbers of parties (applicants) and counter-parties (progs). Both axes use log10 scales. The first line 602 illustrates the execution time of the Gale-Shapley technique, while the second line 604 illustrates the execution time of the embodiment of the present disclosure, which used the mixed integer linear programming technique described above.

The embodiment of the present disclosure achieved statistically significant improved execution time versus Gale-Shapley. The median run time for the embodiment was 52% of that of Gale-SHapley for 90 paired experiments across the illustrated range of party and counter-party sizes. The one-sided paired t-test of execution times for the 90 experiments had a p-value of 0.01, showing that the embodiment of the present disclosure was significantly faster than Gale-Shapley.

Further, the implementation of the present disclosure significantly reduced memory consumption versus standard mixed integer linear programming solvers. A standard mixed integer linear programming solver would require k*N*P+N²*P+P²*N memory, with the extra memory requirements due to the constraints of the solver. For typical match problems for which the presently disclosed techniques may be used, N and P are on the order of thousands and hundreds, respectively. The use of sparse representations for the constraints allowed a memory savings of almost 3 orders of magnitude. For example, for an example having 2500 parties and 300 counter-parties, the sparse representation version of the solver used 0.076 GB of storage versus 16.690 GB for the standard solver.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method of matching parties in a set of parties with counter-parties in a set of counter-parties, the method comprising:
receiving, by a computing system, counter-party preferences from each party in the set of parties;
receiving, by the computing system, party preferences and indications of available positions from each counter-party in the set of counter-parties;
computing, by the computing system, a globally optimal pairing of parties of the set of parties with counter-parties of the set of counter-parties; and
storing, by the computing system, the globally optimal pairing.

2. The computer-implemented method of claim 1, wherein computing the globally optimal pairing of parties of the set of parties with counter-parties of the set of counter-parties includes using an optimization technique in which a global utility function derived from the preferences of the parties and the preferences of the counter-parties is maximized subject to constraints on a solution space.

3. The computer-implemented method of claim 2, wherein using an optimization technique in which the global utility function is maximized subject to constraints on the solution space includes using a mixed integer linear programming technique.

4. The computer-implemented method of claim 3, wherein using the mixed integer linear programming technique includes minimizing a linear combination f^{T}ₓ subject to:
$${min}_{x} {f}^{T} x subject to \{ \begin{matrix}x ( i n t c o n ) are integers \\ A \cdot x \leq b \\ Aeq \cdot x = beq \\ lb \leq x \leq ub\end{matrix}$$
wherein x is a matrix that corresponds to a p×n pairing matrix, where p is a number of parties in the set of parties and n is a number of counter-parties in the set of counter-parties;
wherein intcon is a vector of integer constraints;
wherein b is a vector indicating available positions for each counter-party;
wherein beq is a number of available positions for all counter-parties;
wherein lb is a vector of 0 values indicating a lack of a match;
wherein ub is a vector of 1 values indicating a presence of a match;
wherein A is a linear inequality constraint matrix;
wherein Aeq is a linear equality constraint matrix; and
wherein f is a p×n coefficient matrix that corresponds to combined party preferences and counter-party preferences.

5. The computer-implemented method of claim 4, wherein a sparse representation is used for at least one of the constraints.

6. The computer-implemented method of claim 2, wherein using an optimization technique in which the global utility function is maximized subject to constraints on the solution space includes using a linear programming technique, a quadratic programming technique, a simplex technique, a Nelder-Mead technique, an interior point technique, an active-set technique, a Lagrangian technique, an augmented-Lagrangian technique, a gradient technique, a conjugate gradient technique, a nonlinear programming technique, an entropy maximization technique, or a convex optimization technique.

7. The computer-implemented method of claim 1, wherein receiving party preferences from each counter-party in the set of counter-parties includes receiving, from each counter-party, scores for one or more of the parties in the set of parties, wherein the scores are specified as a relative ordered ranking; and
wherein the method further comprises normalizing the scores for each counter-party to tier values based on the available positions for the corresponding counter-party.

8. A computing system, comprising:
at least one processor; and
a computer-readable medium having computer-executable instructions stored thereon that, in response to execution by the at least one processor, cause the computing system to perform actions for matching parties in a set of parties with counter-parties in a set of counter-parties, the actions comprising:
receiving, by the computing system, counter-party preferences from each party in the set of parties;
receiving, by the computing system, party preferences and indications of available positions from each counter-party in the set of counter-parties;
computing, by the computing system, a globally optimal pairing of parties of the set of parties with counter-parties of the set of counter-parties; and
storing, by the computing system, the globally optimal pairing.

9. The computing system of claim 8, wherein computing the globally optimal pairing of parties of the set of parties with counter-parties of the set of counter-parties includes using an optimization technique in which a global utility function derived from the preferences of the parties and the preferences of the counter-parties is maximized subject to constraints on a solution space.

10. The computing system of claim 9, wherein using an optimization technique in which the global utility function is maximized subject to constraints on the solution space includes using a mixed integer linear programming technique.

11. The computing system of claim 10, wherein using the mixed integer linear programming technique includes minimizing a linear combination f^{T}ₓ subject to:
$${min}_{x} {f}^{T} x subject to \{ \begin{matrix}x ( i n t c o n ) are integers \\ A \cdot x \leq b \\ Aeq \cdot x = beq \\ lb \leq x \leq ub\end{matrix}$$
wherein x is a matrix that corresponds to a p×n pairing matrix, where p is a number of parties in the set of parties and n is a number of counter-parties in the set of counter-parties;
wherein intcon is a vector of integer constraints;
wherein b is a vector indicating available positions for each counter-party;
wherein beq is a number of available positions for all counter-parties;
wherein lb is a vector of 0 values indicating a lack of a match;
where ub is a vector of 1 values indicating a presence of a match;
wherein A is a linear inequality constraint matrix;
wherein Aeq is a linear equality constraint matrix; and
wherein f is a p×n coefficient matrix that corresponds to combined party preferences and counter-party preferences.

12. The computing system of claim 11, wherein a sparse representation is used for at least one of the constraints.

13. The computing system of claim 9, wherein using an optimization technique in which the global utility function is maximized subject to constraints on the solution space includes using a linear programming technique, a quadratic programming technique, a simplex technique, a Nelder-Mead technique, an interior point technique, an active-set technique, a Lagrangian technique, an augmented-Lagrangian technique, a gradient technique, a conjugate gradient technique, a nonlinear programming technique, an entropy maximization technique, or a convex optimization technique.

14. The computing system of claim 8, wherein receiving party preferences from each counter-party in the set of counter-parties includes receiving, from each counter-party, scores for one or more of the parties in the set of parties, wherein the scores are specified as a relative ordered ranking; and
wherein the actions further comprise normalizing the scores for each counter-party to tier values based on the available positions for the corresponding counter-party.

15. A non-transitory computer-readable medium having computer-executable instructions stored thereon that, in response to execution by at least one processor of a computing system, cause the computing system to perform actions for matching parties in a set of parties with counter-parties in a set of counter-parties, the actions comprising:
receiving, by the computing system, counter-party preferences from each party in the set of parties;
receiving, by the computing system, party preferences and indications of available positions from each counter-party in the set of counter-parties;
computing, by the computing system, a globally optimal pairing of parties of the set of parties with counter-parties of the set of counter-parties; and
storing, by the computing system, the globally optimal pairing.

16. The non-transitory computer-readable medium of claim 15, wherein computing the globally optimal pairing of parties of the set of parties with counter-parties of the set of counter-parties includes using an optimization technique in which a global utility function derived from the preferences of the parties and the preferences of the counter-parties is maximized subject to constraints on a solution space.

17. The non-transitory computer-readable medium of claim 16, wherein using an optimization technique in which the global utility function is maximized subject to constraints on the solution space includes using a mixed integer linear programming technique.

18. The non-transitory computer-readable medium of claim 17, wherein using the mixed integer linear programming technique includes minimizing a linear combination f^{T}ₓ subject to:
$${min}_{x} {f}^{T} x subject to \{ \begin{matrix}x ( i n t c o n ) are integers \\ A \cdot x \leq b \\ Aeq \cdot x = beq \\ lb \leq x \leq ub\end{matrix}$$
wherein x is a matrix that corresponds to a p×n pairing matrix, where p is a number of parties in the set of parties and n is a number of counter-parties in the set of counter-parties;
wherein intcon is a vector of integer constraints;
wherein b is a vector indicating available positions for each counter-party;
wherein beq is a number of available positions for all counter-parties;
wherein lb is a vector of 0 values indicating a lack of a match;
wherein ub is a vector of 1 values indicating a presence of a match;
wherein A is a linear inequality constraint matrix;
wherein Aeq is a linear equality constraint matrix; and
wherein f is a p×n coefficient matrix that corresponds to combined party preferences and counter-party preferences.

19. The non-transitory computer-readable medium of claim 18, wherein a sparse representation is used for at least one of the constraints.

20. The non-transitory computer-readable medium of claim 15, wherein receiving party preferences from each counter-party in the set of counter-parties includes receiving, from each counter-party, scores for one or more of the parties in the set of parties, wherein the scores are specified as a relative ordered ranking; and
wherein the actions further comprise normalizing the scores for each counter-party to tier values based on the available positions for the corresponding counter-party.
